(19) United States
(12) Patent Application Publication
(10) Pub. No.: US 2024/0125244 A1
(43) Pub. Date: Apr. 18, 2024

(54) SYSTEM WITH ELECTRIC ACCUMULATOR FOR MORE QUICKLY STARTING UP A STEAM TURBINE, AND METHOD

(71) Applicant: Siemens Energy Global GmbH & Co. KG, Munich, Bayern (DE)

(72) Inventor: Günther Ebner, Gerhardshofen (DE)

(73) Assignee: Siemens Energy Global GmbH & Co. KG, Munich, Bayern (DE)

(21) Appl. No.: 17/769,408

(22) PCT Filed: Oct. 1, 2020
(86) PCT No.: PCT/EP2020/077548

§ 371 Date: Apr. 15, 2022

(30) Foreign Application Priority Data
Oct. 29, 2019 (DE) 10 2019 216 616.4

(51) Int. Cl. F01D 15/10; F01K 23/16

(52) U.S. Cl. CPC F01D 15/10; F01K 23/16; F05D 2220/76; F05D 2260/42

(57) ABSTRACT

By using an accumulator which is charged by a generator upon starting up a steam turbo set, the steam turbo set can be started up more quickly. Energy generation plant, which has at least: a steam turbine and a generator, wherein the generator can be driven at least by the steam turbine, and optionally a gas turbine, which also the generator can drive, the generator electricity for electrical and can generate networks, with an electrical storage device, in particular an accumulator, which can optionally be connected to the generator in order to be charged, in particular when the generator is not connected to the electrical network.

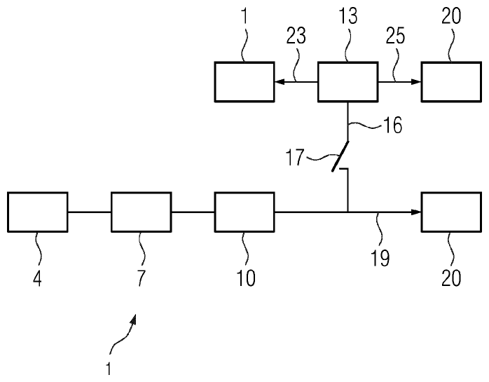

### CROSS REFERENCE TO RELATED APPLICATIONS

This application is the US National Stage of International Application No. PCT/EP2020/077548 filed 1 Oct. 2020, and claims the benefit thereof. The International Application claims the benefit of German Application No. 10 2019 216 616.4 filed 29 Oct. 2019. All of the applications are incorporated by reference herein in their entirety.

### FIELD OF INVENTION

The invention relates to the use of an electrical storage device, in particular an accumulator, for more quickly starting up a steam turbine.

### BACKGROUND OF INVENTION

The start-up process for a steam turbine or a steam turbogenerator set requires components of the turbine(s) to be fully heated to a high level.

For this purpose, the steam turbine is kept at a specific, low heat-up rotation speed in the state in which it is electrically isolated from the grid, where no current can be fed into the electrical grid in the process on account of the excessively low rotation speed.

This full heating at the heat-up rotation speed is achieved by the through-flowing steam which is required and generated to keep the steam turbine at the heat-up rotation speed.

Acceleration (speeding up) with a steam turbine that has not been fully heated leads to damage.

This full-heating process takes a very long time since the through-flowing quantity of steam for maintaining the heat-up rotation speed is very low.

The low-pressure part is usually not fully heated at all because the low-pressure valves are still closed due to the low steam requirement.

The waiting time until the steam turbine is sufficiently fully heated and can be further accelerated can take up to 8 hours. Excess, generated steam is discharged here via the steam bypass station and precipitated in unused form in the condenser.

### SUMMARY OF INVENTION

An object of the invention is therefore to solve the above-mentioned problem.

This object is achieved by a system and a method as claimed.

The dependent claims list further advantageous measures which can be combined with one another as desired in order to achieve further advantages.

An electrical storage device, such as an electrical accumulator in particular, charges a generator and therefore a turbine coupled to said generator, such as a steam turbine in particular, during charging operation.

As a result, more steam power is required in order to maintain the heat-up rotation speed of the steam turbine, this in turn leading to an increase in the steam throughput, without increasing the rotation speed.

As a result, the steam turbine is fully heated substantially more quickly and the energy is electrically stored in the accumulator.

Therefore, said energy is not lost via the steam bypass station.

The greater quantity of steam is advantageously drawn from the energy deposited in unused form and is advantageously not generated additionally.

Rundown of a turbine or of turbines, such as a steam turbine or a steam turbogenerator set in particular, can last up to 1.5 hours.

Proceeding from this concept (quicker starting) with the same electrical configuration, recuperation of the rundown energy from turbines, such as a steam turbogenerator set in particular, is also possible.

In this case, the generator is removed from the grid and connected to the accumulator.

This rundown energy is converted into electrical power by means of the generator and charged into the accumulator.

The shaft train is therefore braked more quickly and passes through the critical rotation speed ranges more quickly.

This concept can be applied both in self-excited and externally excited generators.

Advantages of the invention: —shortening the heat-up time of the steam turbine to half the time, —recovering energy from the rundown energy, —reducing the losses by shortening and reducing the steam bypass operation, —extending the service life of the steam turbine by quickly running through the critical rotation speeds during rundown, —improving the efficiency of the system and therefore reducing emissions, —saving fuel due to shorter start-up times and therefore lower CO₂ emission.

Technical features: —electrically incorporating an electrical accumulator into an existing system or as part of a new construction project.

The level of the heat-up rotation speed takes place as is usual in the prior art.

For the quick start-up, the generator is connected as described above, so that rapid full heating can take place before the generator is coupled to the grid.

The larger the steam turbine, the longer the heat-up process lasts.

### BRIEF DESCRIPTION OF THE DRAWINGS

The FIGURE schematically shows a system 1 according to the invention.

### DETAILED DESCRIPTION OF INVENTION

The FIGURE and the description present only exemplary embodiments of the invention.

A steam turbine and a (steam) turbogenerator set are considered to be equivalents in the text which follows, as are the terms: rechargeable battery, electrical storage device, accumulator, etc.

The FIGURE shows an exemplary power-generating system 1.

The power-generating system 1 comprises at least one steam turbine 7, which has at least one, in particular only one, generator 10 for generating electricity 19.

During regular operation, the electricity 19 is passed on to end consumers via electrical grids 20.

When the steam turbine 7 runs down, the generator 10 can be removed from the electrical grid 20.

The generator 10 is advantageously not connected to the electrical grid 20 during starting, that is to say during full heating.

A gas turbine 4, which is coupled to the steam turbine 7 and the generator 10 in a combined-cycle process, may optionally also be present. The gas turbine 4 is less time-critical than the steam turbine 7 in the event of a quick start.

Further variants of power-generating systems comprising a gas turbine 4, a steam turbine 7 or turbogenerator set etc. and also multi-shaft systems are likewise conceivable.

The main feature is, however, the presence of an electrical storage device 13.

The electrical storage device 13 is charged by the generator 10 via a line 16 when the steam turbine 7 or steam turbine turbogenerator set runs down and/or when maintaining the heat-up rotation speed and when starting-up the steam turbine 7.

The line 16 can be selectively connected to the generator 10 by means of a switch 17.

The electrical energy stored in the storage device 13 can once again be used, via lines 25, to operate one or more grids 20 or is used internally for the system (via line 23).

A “boiler” or core reactor can also be used as the heat source for the steam, that is to say the heat source is not limited to gas turbines.

The concept can be used not only for quick starting, but also for a “stand-by” solution in which the steam turbine is kept at the warm-up rotation speed, is kept well fully heated and can then be “immediately” sped up further.

1. A power-generating system, comprising:
a steam turbine, and
a generator, wherein the generator an be driven at least by the steam turbine, and
optionally a gas turbine which likewise can drive the generator,
wherein the generator can generates electricity for an electrical grid,
wherein an electrical storage device, is present, which electrical storage device is optionally connected to the generator in order to be charged.

2. The power-generating system as claimed in claim 1,
wherein energy of the electrical storage device is used for electrical grids or for the power-generating system itself.

3. A method for operating a power-generating system as claimed in claim 1 which power-generating system at least has: a steam turbine, wherein the steam turbine has to be fully heated for quick starting, and a generator which is driven at least by the steam turbine, and also optionally a gas turbine which likewise can drive or drives the generator, wherein the generator is coupled to the steam turbine and an electrical storage device for quickly starting the power-generating system, so that the steam turbine is fully heated more quickly, the method comprising:
charging the electrical storage device as a result,
and/or
wherein, when the steam turbine or a steam turbogenerator set runs down, removing the generator from the electrical grid and then charging an electrical storage device.

4. The method as claimed in claim 3, further comprising:
generating additional steam by the gas turbine.

5. The method as claimed in claim 4,
wherein the additional steam is drawn from energy deposited in unused form.

6. The method as claimed in claim 3, further comprising:
using a boiler or core reactor as a heat source for steam.

7. A method for changing a power-generating system which at least has: a steam turbine, wherein the steam turbine has to be fully heated for quick starting, and a generator which is driven at least by the steam turbine, and also optionally a gas turbine which likewise can drive or drives the generator, the method comprising:
installing an electrical storage device, which electrical storage device can be connected to the generator in order to be charged by the generator.

8. The power-generating system as claimed in claim 1,
wherein the electrical storage device comprises an accumulator.

9. The power-generating system as claimed in claim 1,
wherein the electrical storage device is optionally connected to the generator in order to be charged, when the generator is not connected to the electrical grid.

10. The method for operating a power-generating system as claimed in claim 3,
wherein the electrical storage device comprises an accumulator.

11. The method as claimed in claim 5,
wherein the additional steam is not generated additionally.

12. The method as claimed in claim 7,
wherein the electrical storage device comprises an accumulator.
